(19) United States
(12) Patent Application Publication
(10) Pub. No.: US 2025/0269392 A1
(43) Pub. Date: Aug. 28, 2025

(54) Wireless Calibration of Electronic Applicator Controls

(71) Applicant: Stinger Equipment Inc., Buckner, KY (US)

(72) Inventors: David Michael Cook, Jekyll Island, GA (US); Stephen W. Brewer, New Albany, IN (US)

(21) Appl. No.: 18/918,790

(22) Filed: Oct. 17, 2024

Related U.S. Application Data
(60) Provisional application No. 63/544,579, filed on Oct. 17, 2023.

(51) Int. Cl. B05B 12/00; A01C 15/00; A01C 23/04

(52) U.S. Cl. CPC B05B 12/00; A01C 15/006; A01C 23/047

(57) ABSTRACT

Implementations disclosed herein are directed to an applicator machine. In some implementations, the application machine includes a frame; a hopper mounted to the frame to hold and dispense a granule product, where the hopper further includes one or more electronically controlled gates; an interface to receive input from a user, where the interface is wirelessly connected with the applicator machine; a calibration key; a controller coupled to the operator control interface and the one or more electronically controlled gates. The controller may calibrate a hopper gate minimum open for a known minimum position, calibrate a hopper gate maximum open for a known maximum position, and save the minimum open flow rate and the maximum open flow rate.

### BACKGROUND OF THE INVENTION

As turf equipment continues to advance with technology, electronic controls are helping to automate and regulate routine functions on equipment. These controls are relatively simple, but this simple automation and regulation of equipment makes work easier and more accurate, which may minimize human errors. Specifically, turf applicators are beginning to use control systems to operate the spraying and spreading functions. In some instances, these controls may be a simple controller to regulate and control pump speed, to regulate pressure, and/or a full functioning control system capable of operating the entire sprayer system. Some machines include simple controls that help automate functions on a fertilizer spreader to control the impeller's variable speed to control the spreading width or a full functioning controller to operate the entire spread system.

These commercially available controls may come with basic software loaded, but they include very limited ability, if any, for the user to customize or otherwise make changes to the functions. In the instances where changes are possible, these changes are normally done through the control panel with a time intensive process that is difficult for the end user.

Calibrating turf applicators with or without a control system may be a lengthy and difficult process if done correctly. Due to the time and technical challenges in calibration of a turf applicator many users visually estimate the initial settings. These users may then use the machine for one to two days and then adjust the settings for accuracy. Other calibration processes include measuring out an area and spread or spray a product in this area and then see how much product was used. This process may be more accurate than pure estimation, but because the area tested is small and the resolution of the measuring system is inadequate, reliable and repeatable calibration may not be achieved. Even this process requires adjustment to dial the rates for increased accuracy.

With respect to dispensing granular material, fertilizer hoppers are designed to limit the hopper gate opening, so as to deliver a specific amount of granular product every time the gate opens to this specific setting. Over time, this setup wears and there may be an increase in the variation or error, which can become apparent to the operator. Further, although machines may be calibrated collectively, the variation from machine to machine becomes greater over time. Large lawn care companies who run fleets of machines have reported that a single setting across the machines cannot be relied on due to unit-to-unit variation. Each machine must be calibrated and then adjusted over the first few days to make the calibration more accurate. The goal for most operators using these common calibration practices discussed herein is to stay within about 80% of the target application rate.

There is a need in the industry to quickly and accurately calibrate a turf applicator for both spreading and/or spraying. This calibration should be able to be easily shared or transferred to other fleet machines and still maintain a high degree of accuracy. This device should allow fleet users to set up multiple pieces of equipment identically and efficiently. Additionally, there is a need to reduce spreader to spreader variation from the factory, as well as variation from machine to machine after they have been used for hundreds of hours in the field. Similarly, there is a need for turf sprayers to be able to compensate for spray tip to spray tip variation over time. Similar to the hopper gate opening described above, as spray tips get used they also wear, which results in flow rate increases making them less accurate and increasing the variation between spray tips.

### SUMMARY OF THE INVENTION

There is a need in the industry for a calibration process capable of being automated with little input or calculations required by the operator. The turf applicator control can automate the calibration process where the user is only required to collect the sprayed or spread material in a container and report back to the applicator how much material was captured as well as the width of the spread or spray. The applicator control will take the spread or spray widths and weight of fertilizer or volume of liquid data to calculate an accurate calibration. For example, the process may calculate calibration with greater than 99% accuracy. Additionally, the calibration process also normalizes or eliminates the unit-to-unit variation from machine to machine allowing for calibrations to be shared between turf applicators.

In a first aspect, an applicator machine includes: a frame; a hopper mounted to the frame and configured to hold and dispense a granule product, wherein the hopper further includes one or more electronically controlled gates; an interface to receive input from a user, where the interface is wirelessly connected with the applicator machine; a calibration key; a controller coupled to the operator control interface, the one or more electronically controlled gates, the controller configured to: calibrate, by the controller, a hopper gate minimum open for a known minimum position, where calibration of the hopper gate minimum open includes: placement of the calibration key in a minimum open position; receive a first input, from the interface, dispense, based on the input received from the interface, a first portion of the granular material; receive a first weight input, from the interface; determine, by the controller, a minimum open flow rate based on the first input weight and a first measured dispense time; calibrate, by the controller, a hopper gate maximum open for a known maximum position, wherein calibration of the hopper gate maximum open includes: placement of the calibration key in a maximum open position; receive a second input, from the interface; dispense, based on the input received from the interface, a second portion of the granular material; receive a second weight input, from the interface; determine, by the controller, a maximum open flow rate based on the second input weight and a second measured dispense time; and save, by the controller, the minimum open flow rate and the maximum open flow rate.

In some implementations, the controller is further configured to disable additional user input from the interface. In some implementations, the controller is further configured to wirelessly transmit the saved minimum open flow rate and the maximum open flow rate to a second applicator machine.

In some implementations, the known minimum position is determined through monitoring, by the controller, a force the one or more electronically controlled gates applies against the calibration tool using electrical or mechanical feedback. In some implementations, the known maximum position is determined through monitoring, by the controller, a force the one or more electronically controlled gates applies against the calibration tool using electrical or mechanical feedback.

In some implementations, the interface displays a position of the one or more electronically controlled gates as a percentage.

In another aspect, an applicator machine includes: a frame; a tank configured to hold a liquid product; one or more electronically controlled spray tips configured to dispense the liquid product; an interface to receive input from a user, where the interface is wirelessly connected with the applicator machine; a calibration key; a controller coupled to the operator control interface, the one or more electronically controlled spray tips, the controller configured to: receive a first input, from the interface; dispense, based on the input received from the interface, a first portion of the liquid material; receive a volume input, from the interface; determine, by the controller, a flow rate based on the volume input and a measured dispense time; save, by the controller, the flow rate

In some implementations, the controller is further configured to disable additional user input from the interface. In some implementations, the controller is further configured to wirelessly transmit the saved flow rate to a second applicator machine.

In yet another aspect, a calibration tool for use with an applicator machine, includes: an upper section and a lower section, a protrusion that separates the upper section and the lower section, where the protrusion is perpendicular to a length defined by an axis running through the upper section and the lower section; where the protrusion extends on each of a first side and a second side beyond a width defined by the upper section and lower section; where the lower section has a width of about 1.000 inches and a thickness of about 0.048 inches.

The term “controller” or “processor” is used herein generally to describe various apparatus relating to the operation of the system and the seeding attachment referred to herein. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions.

A processor or controller may be associated with one or more storage media (generically referred to herein as “memory,” e.g., volatile and non-volatile computer memory). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein.

The term “Internet” refers to the global computer network providing a variety of information and communication facilities, consisting of interconnected networks using standardized communication protocols. The apparatuses, controllers and processors referred to herein may be operatively connected to the Internet.

### BRIEF DESCRIPTION OF DRAWINGS

In order that the embodiments may be better understood, embodiments of a wireless calibration of an electronic applicator control system will now be described by way of examples. These embodiments are not to limit the scope of the claims as other embodiments of a spray manifold will become apparent to one having ordinary skill in the art upon reading the instant description. Non-limiting examples of the present embodiments are shown in figures.

FIG. 1 illustrates an applicator control interface consistent with some embodiments described herein.

FIG. 2 illustrates an exemplary screenshot of a connection page from a wireless application consistent with some embodiments described herein.

FIG. 3 illustrates an exemplary screenshot of a security protocol from the wireless application of FIG. 2 consistent with some embodiments described herein.

FIG. 4 illustrates a fertilizer hopper controlled using the applicator control interface of FIG. 1 and the wireless application described herein.

FIG. 5 illustrates an exemplary screenshot of a hopper gate calibration page for the wireless application of FIG. 2.

FIG. 6 illustrates the use of a calibration tool in a servo tray consistent with some embodiments described herein.

FIG. 7 illustrates an exemplary screenshot of the wireless application of FIG. 2 once the minimum calibration points have been set.

FIG. 8 illustrates the use of the calibration tool and servo tray of FIG. 6 showing the maximum opening calibration process.

FIG. 9 illustrates the exemplary calibration tool of FIG. 6 without the servo tray.

FIG. 10 illustrates an exemplary screenshot of a spreader calibration page from the wireless application of FIG. 2.

FIG. 11 illustrates another exemplary screenshot of the spreader calibration page from the wireless application of FIG. 2.

FIG. 12 illustrates an exemplary spreader calibration graph.

FIG. 13 illustrates an exemplary screenshot of the calibration page for calculating a low calibration point from the wireless application of FIG. 2.

FIG. 14 illustrates an exemplary screenshot of the calibration page for calculating a low calibration point from the wireless application of FIG. 2.

FIG. 15 illustrates an exemplary spread calibration table consistent with some embodiments described herein.

FIG. 16 illustrates an exemplary screenshot of a spray preset calibration page for the wireless application of FIG. 2.

FIG. 17 illustrates an exemplary screenshot of the spray calibration for calculating the flow rate from the wireless application of FIG. 2.

FIG. 18 illustrates an exemplary screenshot of the spray calibration page from the wireless application of FIG. 2.

FIG. 19 is an exemplary spray calibration table consistent with some embodiments described herein.

FIG. 20 illustrates an exemplary setup for a fertilizer hopper calibration consistent with some embodiments described herein.

FIG. 21 illustrates an exemplary setup for a spray calibration consistent with some embodiments described herein.

FIG. 22 is a block diagram of a control system consistent with some embodiments described herein.

### DETAILED DESCRIPTION OF INVENTION

There is a need in the industry for a user-friendly way to calibrate, program, and set up electronic controls for turf applicators. Additionally, there is a need to reduce both spreader variation and spray tip variation on a machine. This is needed for both new machines and especially for the fleets of older machines that are expected to run the same calibration and get the same result.

Various figures presented herein illustrate an exemplary operator control interface and/or a user interface of computer, mobile phone, tablet, or other application 1 as described herein. These figures and/or images are merely exemplary and are not intended to be limiting. A person of skill in the art would recognize that the operator control interface of application user interface may vary in appearance.

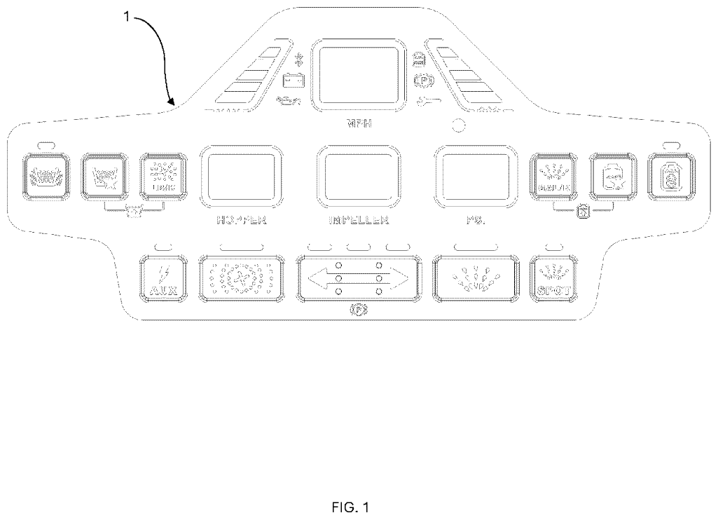

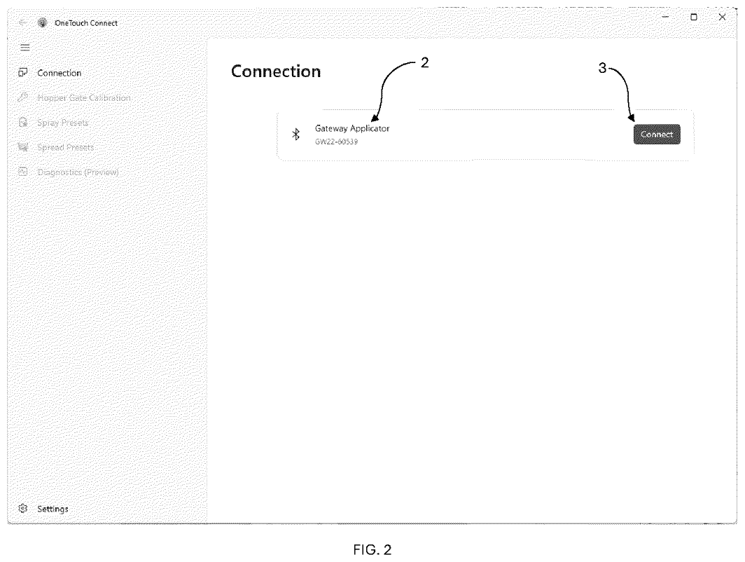

FIG. 1. shows an applicator control interface 1 for a turf applicator, this applicator control interface include both spread and spray control through a single device. This applicator control interface (and associated controller) may automate the process of operating both spread and spray functions of an applicator to a few key inputs from a user. Setting up and programming this device can be done through applicator control interface 1. However, in some instances, the set up and programming of the applicator may be through a wireless application (see FIG. 2)

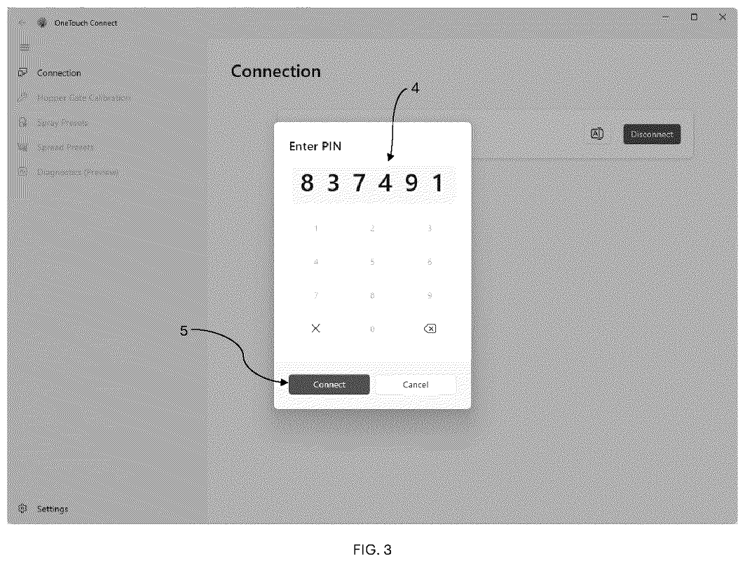

FIG. 2 is an exemplary screenshot of a connection page for a wireless application (e.g., connection through the use of Bluetooth, ZigBee, NFC, or the like) that runs on a computer, mobile phone, tablet, or other computing device. In this example, it shows a “Gateway Applicator” 2 (which is a trade name of the turf applicator utilized in this example and is not intended to be limiting) and the user can select the Connect Button 3 to start the connection process to communicate with the controller of the turf applicator. In this example, FIG. 3 Shows an exemplary screenshot of a security protocol that may be used when connecting to a device. In this example, a user is required to enter a 6-digit code 4. In some instances, this code may change each time a user initially connects the wireless application for added security. In this example the 6-digit is displayed on control interface 1 after the user selects a first “Connect” button 3. After the user enters the code on the device, the user will select a second “Connect” button 5 and the device running the application is now connected to communicate with the controller of the turf applicator. While this security protocol is described and illustrated herein, it is not intended to be limiting. In some implementations, there may not be a security protocol. In other implementations, the security protocol may vary, for example the number or character of the security code may also vary. In some implementations, the security code may be alphanumeric or may include more or less than 6 digits or characters.

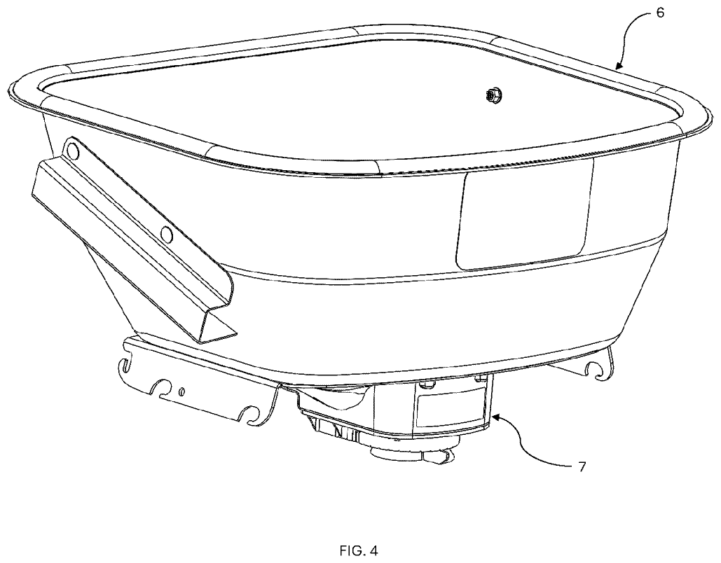

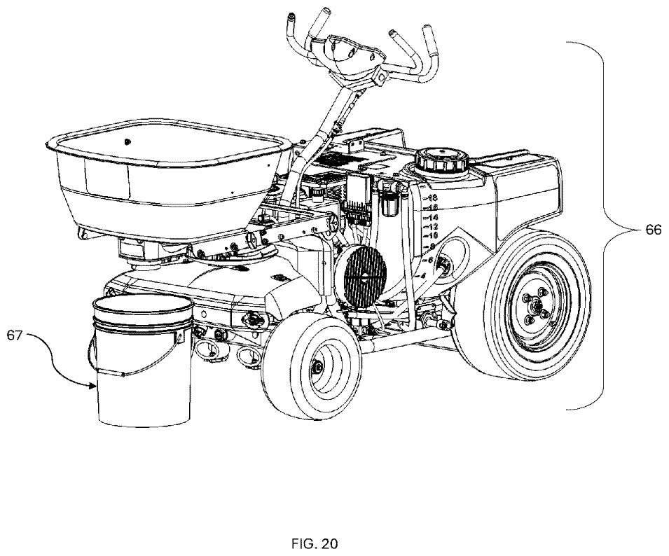

FIG. 4 shows a fertilizer hopper 6 that may be mounted to a frame of an applicator machine (see FIG. 20) and controlled using the electronic controller of the turf applicator. This controller may be setup during manufacturing, but variation in how parts are manufactured, how actuators function, the start and stop points of actuator, the range an actuator travel has includes variations, the having multiple part suppliers may add variation. While each of these variations may be small individually, in this type of application they are additive resulting in a larger variation from machine to machine. As the turf applicator runs over time this variation may continue to increase. These components that may result in variation may make up a servo tray 7 that is attached to the bottom of the fertilizer hopper 6.

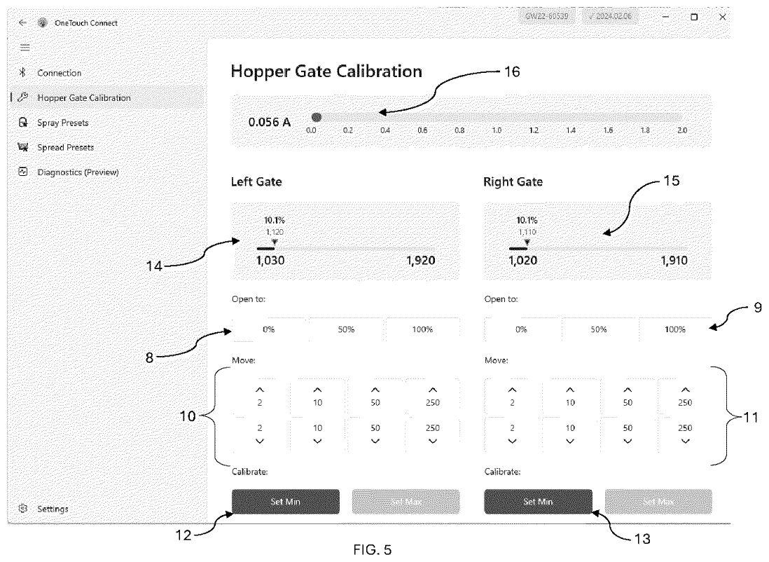

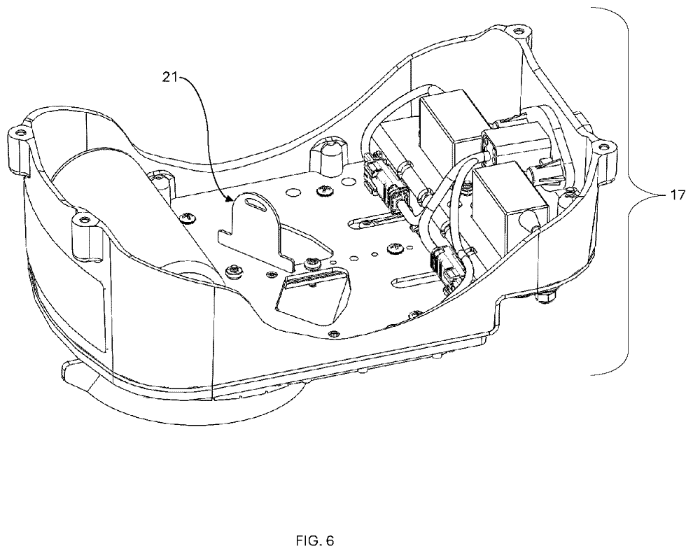

FIG. 5 shows an exemplary hopper gate calibration page for the wireless application, which can run on a computer, mobile phone, tablet, or other device with a wireless communication protocol, such as Bluetooth, ZigBee, NFC, or the like. The calibration page is set up to more accurately calibrate the gate opening positions for the fertilizer hopper as well as eliminate unit to unit variation when the unit is new and/or after thousands of hours of use. The methods described herein also accurately calibrate the minimum and maximum openings to a known distance, which normalizes this variation from machine to machine. For example, during this setup the servo gates may be moved to a particular percentage of opening. This may be done directly by user selection of the 0%, 50%, or 100% buttons shown for each of the left gate buttons 8 and the right gate buttons 9. A first area 14 shows the position and movements of the left gate in real time. A second area 15 shows the position and movements of the right gate in real time. A third area 16 shows the current (in amperes) used by the actuator when moving to the desired location. Providing information regarding the current allows for seeing a load on the actuator. For example, if a user is slowly closing the gate to touch the calibration tool (See FIG. 6 Item 21) and the connection is too tight, the actuator will continue to push against the calibration tool 21 and an operator will be able see the current increase indicating how hard the gate is pushing against the calibration tool. In this example, the current should drop to approximately 0.05 amps when there is no load on the actuator.

FIG. 6 shows a calibration tool 21 being used in the left gate opening to calibrate a minimum gate position on the hopper tray assembly 17. In the illustrated embodiment, the gate is open to around 15% and then slowly moved to a more closed position (e.g., until the gate closes on the calibration tool 21). In this example the calibration tool is made from 14-gauge stainless steel, or in other words is 0.048″ thick; however, this is not intended to be limiting. The calibration tool 21 should remain in a substantially vertical position as shown, so that when aligned correctly the gate should just start to squeeze on the tool without the current on the actuator rising above the normal steady state current which is approximately 0.05 amps. With the gate in the correct minimum calibrated position, the user may then select the “Set Min” button 12 on the application interface to set the minimum calibration point. The entire process is repeated for the right side and the user would press the “Set Min” button 13 to set the minimum calibration for the right gate opening. These positions are saved and used by the controller as the 10% opening position.

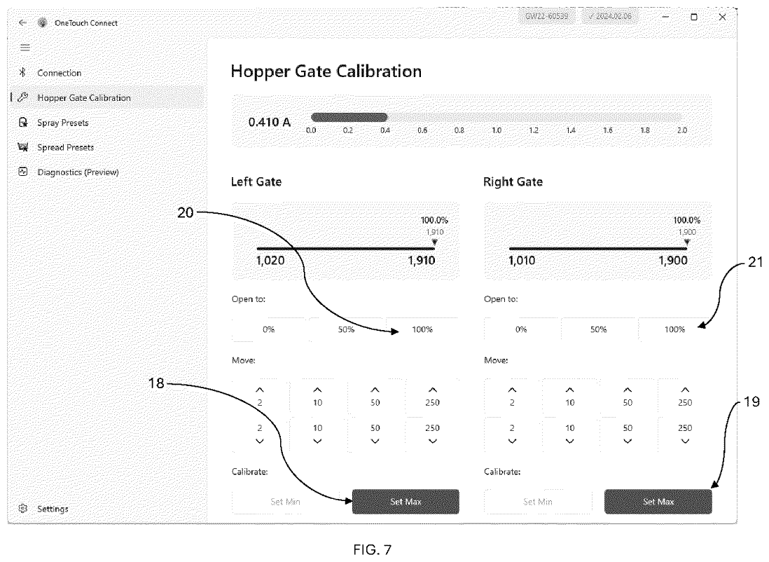

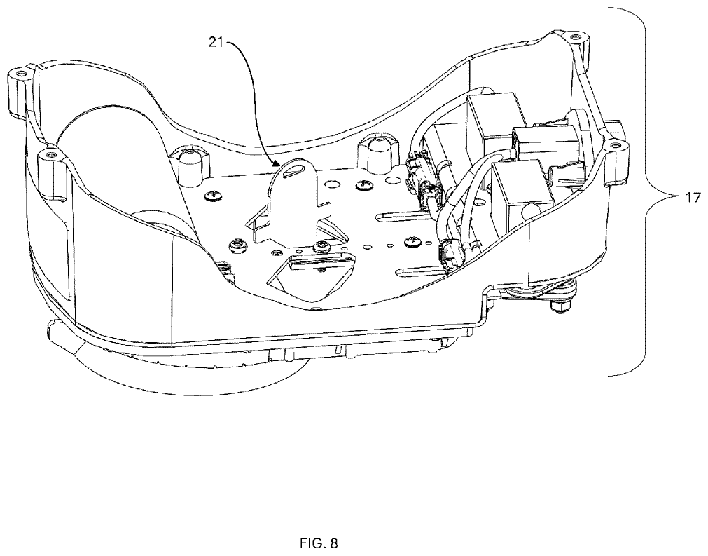

FIG. 7 shows the exemplary application once the minimum calibration points have been set. After setting the minimum calibration points, the user may then set the maximum calibration points. To do this, the user will move both gates to 100% gate opening using “Left Gate 100%” button 20 and the “Right Gate 100%” button0 21. Once the gate has opened a user may select the respective gate's “Set Max” buttons 18, 19. In FIG. 8 shows the maximum opening calibration process with the calibration tool 21 tuned approximately 90 degrees from the minimum calibration process (compare FIG. 6 and FIG. 8). In order to set the maximum calibration, the user will then move the gates close to touching the calibration tool 21 as done previously, except using the wider 1″ distance as shown. In the example illustrated in FIG. 8, the servo tray 17 is set to the max opening to 1.000″. Once each side has been set with the calibration tool 21, the user will select the respective gate's “Set Max” buttons 18, 19. Now the fertilizer hopper gates have been calibrated for the minimum and maximum positions. These positions are saved and used by the controller as the 100% opening position.

This minimum and maximum calibration process minimizes variation from unit to unit. This also minimizes variation for older units that have changed over time. For example, the actuators utilized in these types of machines normally have 1000 steps from a gate closed position to a gate open position. In the illustrated and described example, when the minimum calibration point is set by the user's selection of each of the right and left gates respective “Set Min” buttons 12, 13 the software subtracts 100 steps (e.g., 10% of the total steps) to set the zero or home positions-this would be 0% open. When the user moves the gate to the 100% open positions for each of the right and left gates, which is proximately 1000 sets greater than the home positions. The user may set the max calibration points by selecting the respective “Set Max”) buttons 18, 19, as described previously—this sets the maximum open position. During this process, the software adjusted approximately 1000 steps from the home position previously set. This new maximum position is saved in the software and set for the 100% maximum opening position. Now the each of the right and left gates function on a 0% to 100% open independent of what the steps were prior to the calibration, which normalizes any variation or step size from actuator to actuator or more importantly unit to unit variation.

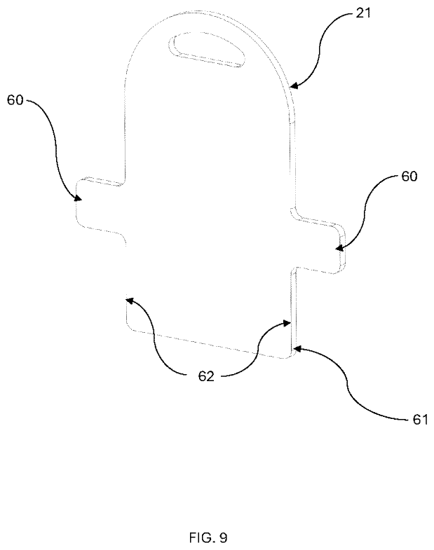

FIG. 9 shows an example of a calibration tool 21 capable of setting both the minimum and maximum positions of the gates. The calibration tool 21 has a thickness of 0.048″ thick 61; it is this thickness that is used for the minimum known position (see FIG. 6). The calibration tool 21 has a lower width section of 1.000″ 62; it is this width that is used for the maximum known position (see FIG. 8). The calibration tool 21 also has an area that protrudes from both sides 60 of the calibration tool 21 and aids where the tool can be placed in the fertilizer gate opening for additional ease of use and accuracy.

Additionally, this calibration process allows for users to download known calibrations for different products and/or share or recall them from other users. Having a known and repeatable calibration and/or range of opening positions allows for more accurate calibrations and repeatability from machine to machine. For example, this may be achieved through use of network connectivity from the machine and/or the application.

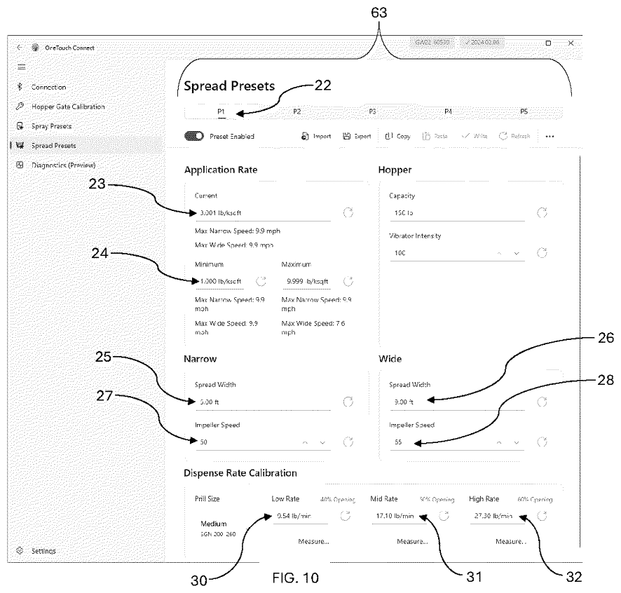

After all of the gate positions have been calibrated. A user would then normally calibrate the specific product they want to apply. The user may calibrate up to five (5) different products or the same products with different settings, or any combination all on the same machine. This allows a user to instantly recall these saved calibration settings. Although this number is merely exemplary and not intended to be limiting. In some implementations, a user may be able to calibrate more or less than 5 different products. FIG. 10 shows an exemplary screenshot of the spreader calibration page. Across the top of the page, a user can select any one of the 5 presets 63. In the illustrated example P1 (Preset 1) 22 is selected and all the available options are shown for this example. For example, the user can then select the application rate 23. In this example, the user has selected 3.0 lbs./1000 sq ft. The user can also set the allowable range 24 within which the machine operator can adjust the rate. For example, if minimum and maximum range were also set to 3.0 lbs./1000 sq ft then the operator of the machine would not be able to adjust the rate of application. This allows a fleet operator to provide control over the adjustment of the machine in the field. In the illustrated example, the user has selected an allowable range 24 with a minimum of 1.0 lb./1000 sq ft and a maximum of 10 lbs/1000 sq ft. In this example, the machine will start at 3.0 lbs/1000 sq ft but the operator could adjust the rate down to 1.0 lb./1000 sq ft or as high as 10 lbs./1000 sq ft. Next the operator may select the width, select both a both wide 25 and a narrow 26 width. This is used by the controller to deliver enough of the selected product(s) to match the width selected by the operator for the speed of the machine. In some implementations, the machine may be setup for a single speed calibration. In other implementations, for example where the machine is ground metered and can adjust the rate to match the ground speed. In this instance, the operator will adjust the narrow impeller speed 27 and the wide impeller speed 28, so that the material width matches the wide 25 and a narrow 26 width used.

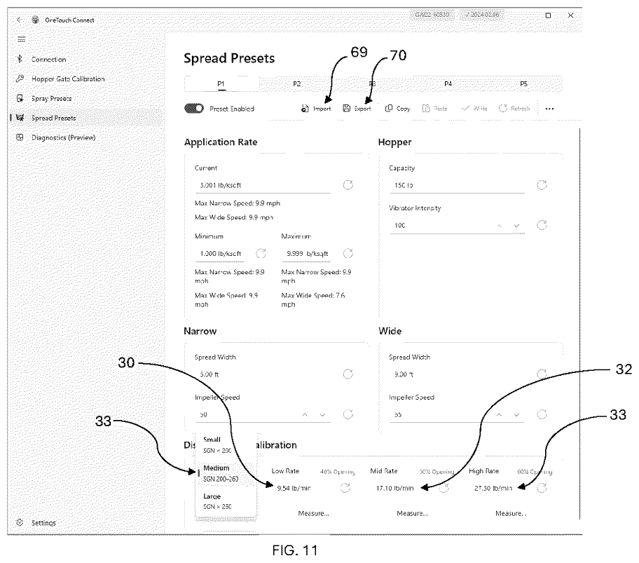

Next, the flow rate of the material needs to be set. In a single speed setup, the flowrate is one setpoint. In a ground metered setup, like shown and described herein, two or more calibration points should be set, for example a low calibration point and a higher calibration point. In the illustrated example, three calibration points are used for increased accuracy. In FIG. 11, the user will select the medium prill size 29 which is the standard unit size for particles spread with a fertilizer spreader. The application may include options of small, medium, or larger particle size, which correlates with the SNG size of the material normally displayed on the manufacturer's bag. In the illustrated settings, the user selected a medium prill size 33, which includes calibrations for a 40% gate opening 30, a 50% gate opening 31, and 60% gate opening 32 positions.

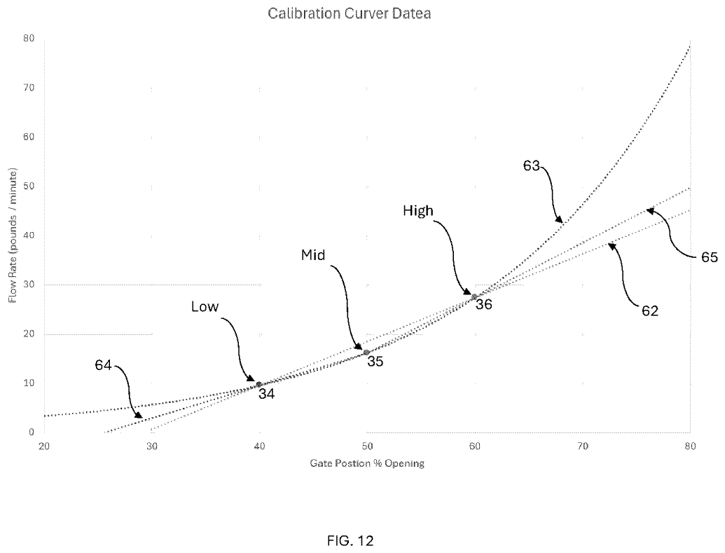

FIG. 12 is a spreader calibration graph that illustrates how the software can utilize two or more calibration points to calculate a calibration for a ground metered applicator. The calibration shown in the illustrated table can interpolate gate opening positions on to match the rate needed based on the ground speed. The application may use similar calculations to determine gate opening positions. The illustrated example has a “Low Rate” 34 calibration point, a “Mid Rate” 35 calibration point, and a “High Rate” 36 calibration point. The gate openings for each these calibration points are known; the “Low Rate” 34 calibration point has a 40% gate opening position, the “Mid Rate” 35 calibration point has a 50% gate opening position, and the “High Rate” 36 calibration point has a 60% gate opening position. The operation range for the gate opening with a medium prill size normally ranges from 35% to 60%. It is clear from the graph how these three data points provide the best interpolation of gate opening to material flow rate.

Where only two data points are present, for example the “Low Rate” 34 and “High Rate” 36 linear regression 62 could be used to interpolate a gate opening to the flow rate. In another example, a gate opening to the flow rate could be interpolated with a linear regression 64 using the “Low Rate” 34 to “Mid Rate” 35 position for all flow rates below the “Mid Rate” calibration point; a second linear regression 65 using the “Mid Rate” 35 to “High Rate” 36 calibration points above the medium calibration point. Another example, an exponential model 63 may be used to calculate the moving gate opening required to match the ground speed. Each of these methods is acceptable, but each and comes with different levels of complexity and accuracy.

For a non-ground metered application, there may be only a single opening position for the widest spread and a single position for the narrowest spread, and these would be set assuming a machine going five (5) mph. This is commonly referred to as single point calibration and is the standard practice in the industry. However, the single point calibration process is more time consuming because the user must repeat the process to dial in the desired opening for the flow rate using an iterative process. For example, if the width, speed, or rate changed, the process would start over. Using two, three, or more known calibrations runs and using data interpolation as described may be faster, more accurate, and more flexible than the previous single calibration point process. With the two-point data interpolation method described herein a calibration can be run once and saved where the user can still change the rate, speed, and width without having to recalibrate the machine.

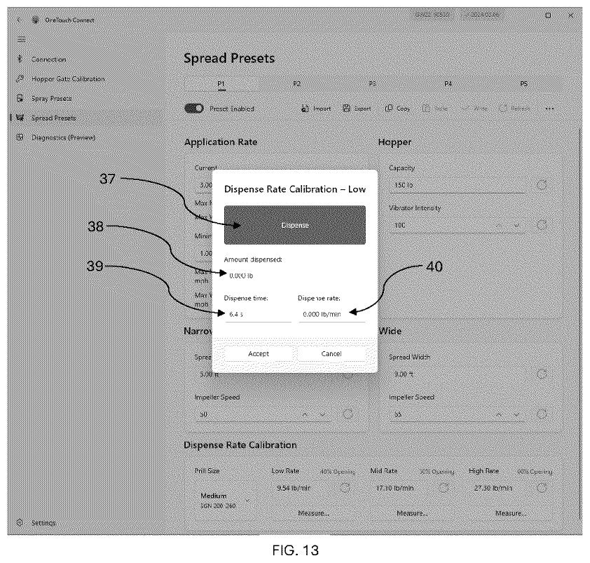

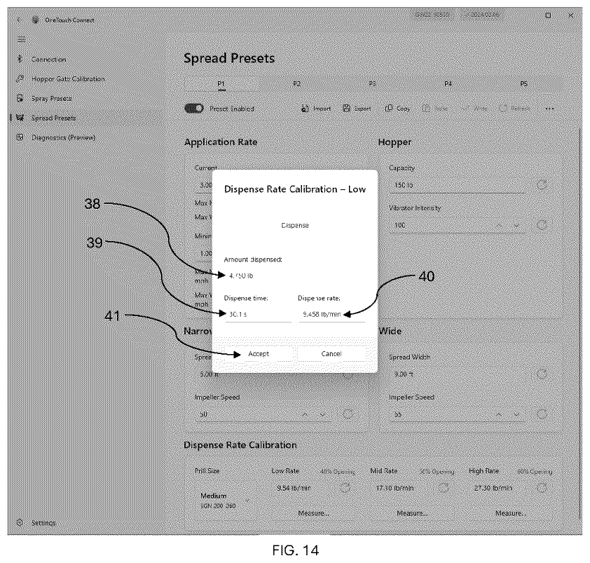

FIG. 13 shows a screenshot of the application calibration page for calculating a low calibration point. In this example, the user would fill the fertilizer hopper with some of the specific product for calibrating. The user would select the “Dispense” button 37 and material will exit the spreader. While dispensing, an amount of time relapsed during the dispensing is shown in the “Dispense time” field 39. s Dispensing will stop when the user selects the “Dispense” button 37 and second time to stop the flow. A user may typically conduct a calibration run for around 30 seconds. The user would set a catch tray or bucket under the hopper to catch the material when dispensed (See FIG. 20). In this example (See FIG. 14), when the gate is open and dispensing product, the “Dispense time” 39 is calculated automatically based on the start and stop times from the user actuation of the dispense button 37. In the illustrated example the hopper was dispensing product for 30.1 seconds. This calibration run could be whatever length the user determines good for their application. The user would then weigh the material collected over the time period and enter the value into the “Amount dispensed” field 38 where the software would calculate the dispense rate 40 of 9.458 lbs./min automatically in this example. The user will then either select the “Accept” button 41 and the flow rate would be saved as the Low Rate calibration value, or the process will be repeated. A user would then repeat this process for the “Mid Rate” and “High Rate” calibration points.

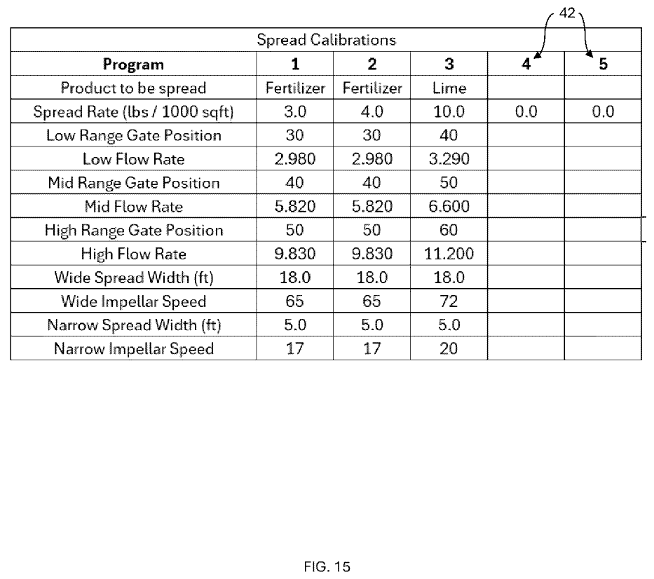

FIG. 15 shows an example of a calibration table. The table illustrates the five (5) preset programs and the data that may be saved by the user and then pulled by the operator on the machine when spreading. In this example, presets in columns 4 and 5 42 are blank. In this example, the controller would interpret zero or blank data as no calibration stored and would skip over these calibration positions. In the illustrated example, the machine operator could select presets 1, 2, and 3 only.

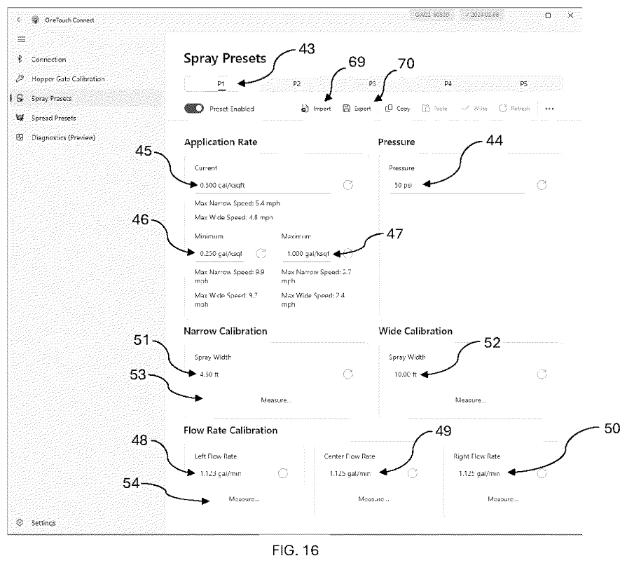

FIG. 16 shows a screenshot of the application page to calibrate the spray presets. The application allows a user to calibrate a flow rate of each spray tip individually or just one spray tip and then the user manually enters the same value for all spray tips. Calibrating each spray tip individually is more accurate and will reduce flow rate variation from tip to tip when calibrating new spray tips with old spray tips on the same machine. As spray tips get used, they begin to increase in higher flow rate compared to a new spray tip. This calibration process is capable of compensating for different flow rates on each spray tip so the user can get the same application rate.

In the illustrated example, the user has selected calibration P1 (Preset 1) 43. The user will enter the desired data: Spray Pressure 44, Application Rate (gal/1000 sq ft) 45, minimum application rate 46, maximum application rate 47. Once this data is entered, the user will calibrate the flow rate of the tip or tips. The flow rates are shown from left to right: left 48, center 49, and right 50. The width of the spray pattern is also shown for both a narrow 51 and wide 52 spray pattern. To determine the narrow spray width, the user can select button 51 to turn on the narrow spray to determine the spray width. The user can do this same process to determine the wide spray width. The flow rates (48, 49, 50) and widths (51, 52) are used by the software to calculate how much flow is needed to match the desired flow rate with the ground speed to achieve the desired spray rate 45.

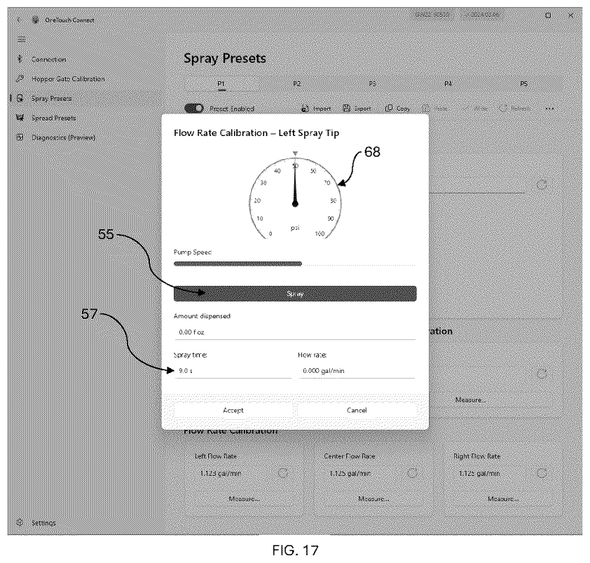

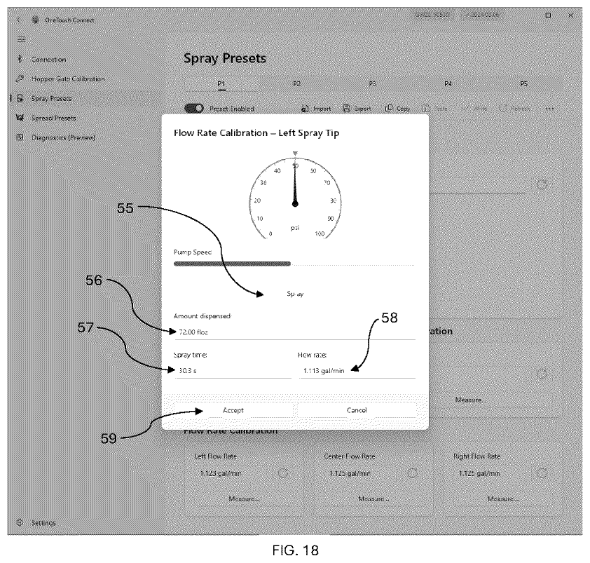

To calibrate the tip flow rates, the user will select the “Measure” button 54, in this example for the left spray tip. This will open the window shown in FIG. 17 to assist the user in calculating the flow rate. The user will select the “Spray” button 55 and the spray will start out of the left spray tip at the user selected pressure (here 50 psi). The spray pressure is displayed 68 in real time. The amount of time the sprayer is on is displayed as “Spray time” 57. FIG. 18 shows where the user will select the “Spray” button 55 a second time to stop the flow. In some implementations, the user will use a pitcher with volumetric measurements to capture the liquid dispensed from the spray tip; however, the user may collect and measure the dispensed liquid in any number of ways. In this example, the spray tip was dispensing for 30.3 seconds as shown in the “spray time” 57. The user will then enter the amount of fluid dispensed (72 oz) in the “amount dispensed” field 56. The application then calculates the flow rate, given the amount of fluid dispensed and the amount of time the spray tip was on. The “flow rate” 58 of 1.113 gal/min is displayed. This process should be repeated for all spray tips, or in the alternative, the user could enter this same flow rate manually (if using only new spray tips).

In this example, the machine is ground metered, so it is capable of pulsing the spray tips on and off 20-30 times a second to decrease the flow rate to match the ground speed. For a non-ground metered spray system where the unit would just spray at a single speed, the flow rate would be used with a known ground speed and the user would mix the spray solutions to match the flow rate, width, and ground speed for the setup.

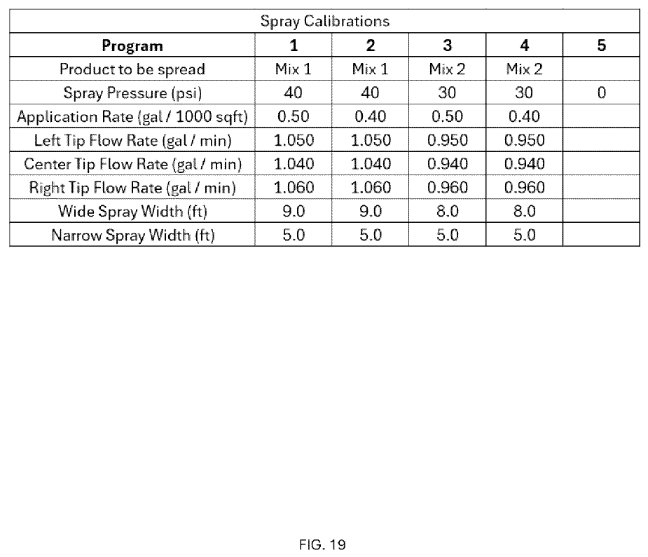

FIG. 19 shows an example of a spray calibration table. In some implementations, more or less data may be contained in a spray calibration table. The data shown in the table may be the same data collected by the user and application as described previously. This data may be shared between different turf applicators within a fleet and may also be quickly recalled by the operator by simply selecting through the programs saved. In this example, the operator would be able to choose from P1 through P4 (program 5 has missing or incomplete data).

Once the user has the applicator setup as desired, the user can save or export the settings. FIGS. 11 and 16 show an “export” button 69 and an “import” 70 button to export or import calibration data. The user can export 70 each calibration page and give the data a custom file name to be used later or to email to another person. In the same way, if the user had calibration data created previously or emailed by another user, the operator could locate the export file and then import 69 the data into the machine.

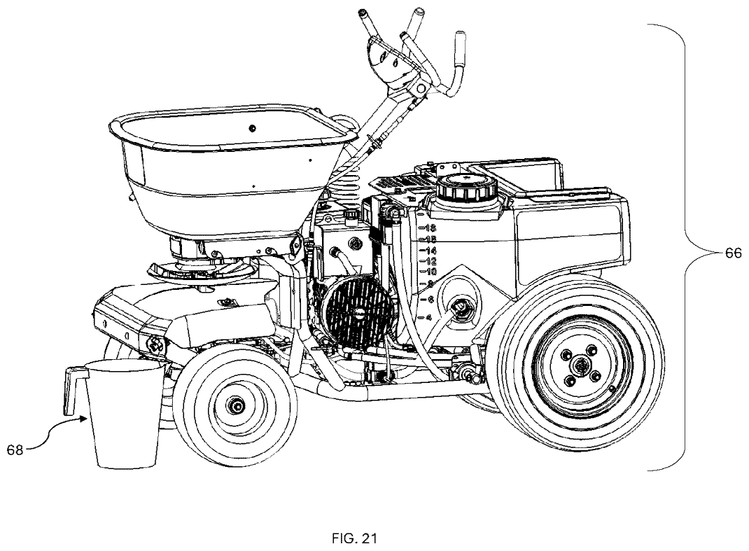

FIG. 20 shows a typical setup for a fertilizer hopper calibration. The turf applicator 66 has a bucket 67 to catch the material that is dispensed during the calibration process. Similarly, FIG. 21 shows a typical setup for a spray calibration. The same turf applicator 66 has volumetric pitcher 68 collecting the fluid from a spray tip.

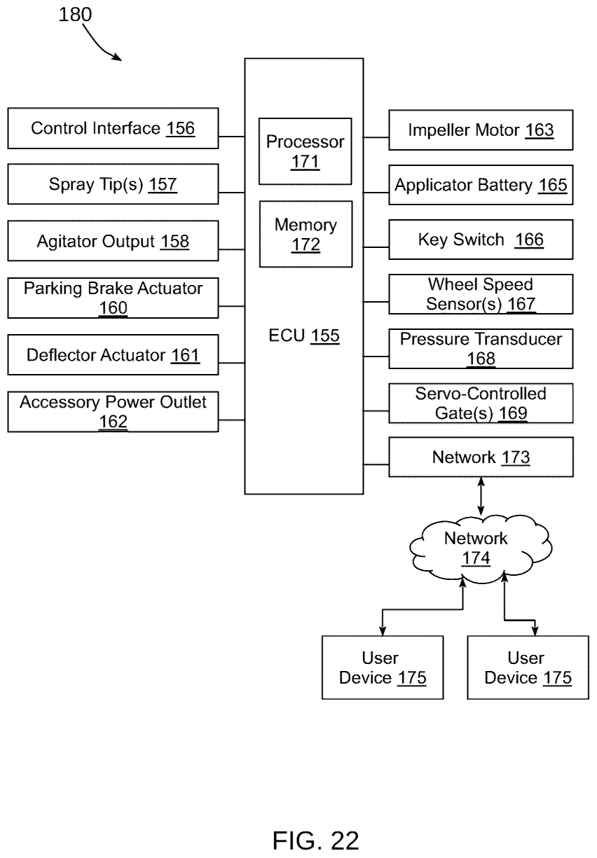

FIG. 22 is a block diagram of an example control system 180 shown and described herein. An applicator control interface 156, as shown in FIG. 1, may in some instances, be an or include electronic control unit (ECU) 155, which may include one or more processors 171 and a memory 172 within which may be stored program code for execution by the one or more processors. The memory may be embedded in the ECU 155 but may also be considered to include volatile and/or non-volatile memories, cache memories, flash memories, programmable read-only memories, etc., as well as memory storage physically located elsewhere from the ECU 155. The ECU 155 may be interfaced with various components. The ECU 155 may interface with various user controls 156; for example, applicator control interface illustrated in FIG. 1. The ECU 155 may also be interfaced with one or more components of the applicator, including but not limited to: spray tip(s) 157, agitator output 158, parking brake actuator 160, deflector actuator 161, additional accessory power output 162, impeller motor output 163, pump motor output 164, vehicle (e.g. applicator) battery 165, vehicle key switch 166, wheel speed sensor(s) 167, pressure transducer 168, servo-control gate(s) 169 for the fertilizer hopper.

In some embodiments, ECU 155 may also be coupled to one or more network interfaces 173, e.g., for interfacing with external devices via wired and/or wireless networks such as Ethernet, Wi-Fi, Bluetooth, NFC, cellular and other suitable networks, collectively represented in FIG. 22 at 174. One non-limiting example of such a network interface may be a Bluetooth chip. Network 174 may incorporate, in some embodiments, wireless protocols, e.g., Wi-Fi or Bluetooth, may be used. In some embodiments, ECU 155 of the applicator may be interfaced with one or more user devices 175 over network 174, e.g., computers, tablets, smart phones, wearable devices, etc., and through which applicator may be controlled and/or may provide user feedback. Various alternative or additional hardware or configurations for network interface 173 will be apparent to one of ordinary skill in the art.

As described in detail herein, an operator may be able to utilize an application of a user device 175 to calibrate a machine or to select from a list of preset or custom calibrations stored that the application of the user device 175. The application may then be able to instruct the applicator machine via network 174 to execute the selected commands. As also mentioned herein, an operator, via user device 175 may also be able to download, for example via network 174, a custom calibration created by an operator and transfer this calibration to one or more other networked applicator machines. A connected user device 175 may also, in some implementations, be able to display detailed application information to the operator either in real time or records or past application for an operator to maintain in their application records. A non-limiting example of the information displayed in real time and/or recorded via the user device 175 include: an amount of area covered during an application; an amount of product applied to that point during an application; an amount of product left in the spreader or spray tank (e.g. range indicator); a summary of product applied after the application; information regarding the area treated after the application (e.g. a map or other description of the area treated). Additionally, in some implementations, an operator may be able to reset the summary information after each application. Traditionally, it may be desired that an operator record area treated and the amount of product applied (e.g. when doing lawn applications), but currently this may be accomplished via inconsistent and inaccurate paper records, that may amount to a best guess of the operator. Such a connected system may allow for more accurate and consistent records that may be easily viewable and sharable with a third party.

While described herein primarily as an ECU, control of one or more of the various components described herein may control through one or more physical components (e.g. cables, chains, etc.) either alone or in combination with an ECU 155.

The term “controller” or “processor” is used herein generally to describe various apparatus relating to the operation of the system and the seeding attachment referred to herein. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions.

A processor or controller may be associated with one or more storage media (generically referred to herein as “memory,” e.g., volatile and non-volatile computer memory). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein.

The term “Internet” refers to the global computer network providing a variety of information and communication facilities, consisting of interconnected networks using standardized communication protocols. The apparatuses, controllers and processors referred to herein may be operatively connected to the Internet.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. An applicator machine, comprising:
a frame;
a hopper mounted to the frame and configured to hold and dispense a granule product, wherein the hopper further includes one or more electronically controlled gates;
an interface configured to receive input from a user, wherein the interface is wirelessly connected with the applicator machine;
a calibration key;
a controller coupled to the operator control interface, the one or more electronically controlled gates, the controller configured to:
calibrate, by the controller, a hopper gate minimum open for a known minimum position, wherein calibration of the hopper gate minimum open includes:
placement of the calibration key in a minimum open position;
receive a first input, from the interface;
dispense, based on the input received from the interface, a first portion of the granular material;
receive a first weight input, from the interface;
determine, by the controller, a minimum open flow rate based on the first input weight and a first measured dispense time;
calibrate, by the controller, a hopper gate maximum open for a known maximum position, wherein calibration of the hopper gate maximum open includes:
placement of the calibration key in a maximum open position;
receive a second input, from the interface;
dispense, based on the input received from the interface, a second portion of the granular material;
receive a second weight input, from the interface;
determine, by the controller, a maximum open flow rate based on the second input weight and a second measured dispense time; and
save, by the controller, the minimum open flow rate and the maximum open flow rate.

2. The applicator of claim 1, wherein the controller is further configured to disable additional user input from the interface.

3. The applicator of claim 1, wherein the controller is further configured to wirelessly transmit the saved minimum open flow rate and the maximum open flow rate to a second applicator machine.

4. The applicator of claim 1, wherein the known minimum position is determined through monitoring, by the controller, a force the one or more electronically controlled gates applies against the calibration tool using electrical or mechanical feedback.

5. The applicator of claim 1, wherein the known maximum position is determined through monitoring, by the controller, a force the one or more electronically controlled gates applies against the calibration tool using electrical or mechanical feedback.

6. The applicator of claim 1, wherein the interface displays a position of the one or more electronically controlled gates as a percentage.

7. An applicator machine, comprising:
a frame;
a tank configured to hold a liquid product;
one or more electronically controlled spray tips configured to dispense the liquid product;
an interface configured to receive input from a user, wherein the interface is wirelessly connected with the applicator machine;
a calibration key;
a controller coupled to the operator control interface, the one or more electronically controlled spray tips, the controller configured to:
receive a first input, from the interface,
dispense, based on the input received from the interface, a first portion of the liquid material;
receive a volume input, from the interface;
determine, by the controller, a flow rate based on the volume input and a measured dispense time;
save, by the controller, the flow rate.

8. The applicator of claim 7, wherein the controller is further configured to disable additional user input from the interface.

9. The applicator of claim 7, wherein the controller is further configured to wirelessly transmit the saved flow rate to a second applicator machine.

10. A calibration tool for use with an applicator machine, comprising:
an upper section and a lower section,
a protrusion that separates the upper section and the lower section, wherein the protrusion is perpendicular to a length defined by an axis running through the upper section and the lower section;
wherein the protrusion extends on each of a first side and a second side beyond a width defined by the upper section and lower section;
wherein the lower section has a width of about 1.000 inches and a thickness of about 0.048 inches.
